(19) United States
(12) Patent Application Publication
(10) Pub. No.: US 2004/0076777 A1
(43) Pub. Date: Apr. 22, 2004

(54) Lid for a disposable beverage container

(76) Inventors: George Leonard Bayss, Randwick New South Wales (AU); Marcel Miller, Woolloomooloo New South Wales (AU)

Correspondence Address: TOWNSEND AND TOWNSEND AND CREW, LLP, TWO EMBARCADERO CENTER, EIGHTH FLOOR, SAN FRANCISCO, CA, 94111-3834, US

(21) Appl. No.: 10/466,032

(22) PCT Filed: Jan. 11, 2002
(86) PCT No.: PCT/AU02/00029

(30) Foreign Application Priority Data
Jan. 12, 2001 (AU) PR 2489
Apr. 20, 2001 (AU) PR4510
Apr. 25, 2001 (AU) PR4555
Jun. 14, 2001 (AU) PR5647

(51) Int. Cl. F16L 1/00

(52) U.S. Cl. 428/34.1

(57) ABSTRACT

A lid (30) for a disposable beverage container (32). The lid (30) including at least a region having thermochromic properties which is/are adapted to change colour upon reaching a predetermined non-ambient temperature in response to heat transfer from or to contents (40) of the container (32). Also disclosed is a lid (60) including at least one recess (62) having an internal side wall or walls (64) that substantially correspond in size and sharpe to the external side wall(s) (66) of a container (68). The lid internal side walls (64) being adapted to securely frictionally engage, over substantially their entire surface area, the external side wall(s) (66) of another like container (68).

### FIELD OF THE INVENTION

The present invention relates to a lid for a disposable beverage container.

The lid has been developed primarily for use with foam or paper cups commonly used in the sale of heated beverages, such as coffee, or chilled beverages, such as soft drinks, and will be described with reference to the former application. However, it will be appreciated that the invention is not limited to this particular use.

### BACKGROUND OF THE INVENTION

Numerous beverage lids and associated containers are known.

Some known lids include small printed or embossed warning signs of HOT or the like. However, a disadvantage of known lids and containers is they do not provide an estimated indication of the actual temperature of the contents of the container, particularly to those not handling the container. Such an estimated indication is desirable for many reasons as will be explained below. An example of two such reasons is improved safety when conveying heated container contents and improved quality control for customers expecting contents of a predetermined temperature.

Lids having recessed outer surfaces for receiving the underside of containers for stacking are also known. However, a disadvantage of such known lids and containers is they do not provide a secure engagement between the lid and container, sufficient to provide safe conveyance of stacked containers with lids.

### OBJECT OF THE INVENTION

It is an object of the present invention to substantially overcome or at least ameliorate one or more of the above disadvantages.

### SUMMARY OF THE INVENTION

Accordingly, in a first aspect, the present invention provides a lid adapted to indicate sealing integrity with respect to a disposable beverage container, the lid including a skirt adapted to seal against an open end of said container and having thermochromic properties whereby the skirt is adapted change colour upon reaching a predetermined non-ambient temperature in response to heat transfer from or to contents of the container.

In a second aspect, the present invention provides a lid adapted to indicate sealing integrity with respect to a disposable beverage container, the lid including a skirt adapted to seal against an open end of said container and having thermochromic properties whereby the skirt is adapted change colour upon reaching a predetermined non-ambient temperature in response to heat transfer from or to contents of the container, wherein, when the skirt is sealed against substantially all of the container end, the end substantially insulates the skirt from the heat transfer and no colour change occurs thereby visually indicating sealing integrity, and

when the lid is not substantially sealed against all of the container end, heat transfer occurs in non-sealed parts of the skirt causing said colour change in said non-sealed skirt parts thereby visually indicating a lack of sealing integrity.

In a third aspect, the present invention provides a lid for a disposable beverage container, the lid being formed from co-extruded inner and outer layers, wherein the outer layer includes at least one region having thermochromic properties, which region(s) is/are adapted to change colour upon reaching a predetermined non-ambient temperature in response to heat transfer from or to contents of the container.

In one form, the lid includes a skirt adapted to substantially sealingly engage an open end of the container and the region is the skirt.

The skirt preferably changes from a first colour to second colour, of brighter or warmer tones than the first colour, when the contents are at the predetermined non-ambient temperature.

In an embodiment, the skirt changes from to a bright red colour when the contents are at a predetermined heated non-ambient temperature. The skirt is preferably violet when the contents are below the predetermined heated non-ambient temperature. The predetermined heated non-ambient temperature is preferably about 45 Degrees Celsius.

In another embodiment, the skirt changes colour to a blue colour to indicate the contents are at a predetermined chilled non-ambient temperature. The skirt is preferably violet when the contents are above the predetermined chilled non-ambient temperature. The predetermined chilled non-ambient temperature is preferably about 5 Degrees Celsius.

The lid is desirably formed from a plastics material and includes region(s) impregnated or blended with a material having thermotropic properties. The material having thermochromic properties is desirably a thermochromic pigment, resin or the like, most desirably CHROMICOLOR (Trade Mark).

The region(s) form preferably words, symbols or patterns against the remainder of the lid when the contents are at the predetermined non-ambient temperature.

The region(s) are preferably adapted to return to their original colour in response to the temperature of the regions falling below the predetermined non-ambient temperature when that temperature is above ambient or rising above the predetermined non-ambient temperature when that temperature is below ambient.

In another form, the lid includes at least two regions having differing thermochromic properties which are each adapted to change to different colours upon reaching differing non-ambient temperatures in response to heat transfer from or to the contents of the container.

In a fourth aspect, the present invention provides a lid for a disposable beverage container, the container having an open end and a closed end defined by external side wall or walls, the lid including at least one recess having an internal side wall or walls that substantially correspond to the container external side wall(s) in size and shape, wherein the lid internal side walls are adapted to securely frictionally engage, over substantially their entire surface area, the external side wall(s) of another like container.

The lid internal side wall(s) preferably engage the external side wall(s) of said another like container over approximately 5 to 15% of the height of said another like container. More preferably, the lid internal side wall(s) engage the external side wall(s) of said another like container over approximately 10% of the height of said another like container.

The lid internal side wall(s) preferably engage the external side wall(s) of said another like container over approximately 5 to 15 mm of the height of said another like container. More preferably, the lid internal side wall(s) engage the external side wall(s) of said another like container over approximately 10 mm of the height of said another like container.

In an embodiment, the lid includes two recesses each having said internal side wall(s), one of the recesses adapted to frictionally engage the closed end of another like container and the other of the recesses adapted to frictionally engage the closed end of another container of smaller or larger size than a like container. In this embodiment, the recess adjacent the container open end is smaller than the recess remote the container open end.

The lid internal side wall(s) of each recess preferably engage the side wall(s) of said another like container over approximately 2.5 to 7.5% of the height of said another like container. More preferably, the lid internal side wall(s) of each recess engage the external side wall(s) of said another like container over approximately 5% of the height of said another like container.

The lid internal side wall(s) preferably engage the external side wall(s) of said another like container over approximately 2.5 to 7.5 mm of the height of said another like container. More preferably, the lid internal side wall(s) of each recess engage the external side wall(s) of said another like container over approximately 5 mm of the height of said another like container.

The recess(es) is/are desirably substantially cylindrical.

The recess(es) is/are desirably slightly outwardly conical.

The recess(es) desirably each include a flat surface adjacent one end of the side wall(s) adapted to, in use, abut the underside of said another like container closed end.

### BRIEF DESCRIPTION OF THE DRAWINGS

Preferred embodiments of the invention will now be described, by way of examples only, with reference to the accompanying drawings in which:

FIG. 1 is a side view of the lid according to a first embodiment of the invention and a correspondingly sized container;

FIG. 2 is a first perspective view of the lid and container shown in FIG. 1;

FIG. 3 is a second perspective view of the lid and container shown in FIG. 1;

FIG. 4 is a perspective view of a lid according to a second embodiment of the invention and a correspondingly sized container;

FIG. 5 is perspective view of a lid according to a third embodiment of the invention and a correspondingly sized container;

FIG. 6 is a side view of the lid according to a fourth embodiment of the invention and a correspondingly sized container;

FIG. 7 is a second side view of the lid and container shown in FIG. 6;

FIG. 8 is a third side view of the lid and container shown in FIG. 6;

FIG. 9 is a fourth side view of the lid and container shown in FIG. 6;

FIG. 10 is a perspective view of a lid according to a fifth embodiment of the invention;

FIG. 11 is a cross sectional side view of the lid sown in FIG. 10;

FIG. 12 is a perspective view of the lid according to a six embodiment of the invention;

FIG. 13 is a cross sectional side view of tie lid shown in FIG. 12;

FIG. 14 is a perspective view of the lid according to a seventh embodiment of the invention;

FIG. 15 is a perspective view of the lid according to an eighth embodiment of the invention;

FIG. 16 is a perspective view of the lid according to a ninth embodiment of the invention;

FIG. 17 is a cross sectional side view of the lid shown in FIG. 15; and

FIG. 18 is a cross sectional side view of the lid according to as tenth embodiment of the invention.

### DETAILED DESCRIPTION OF THE PREFERRED EMBODIMENTS

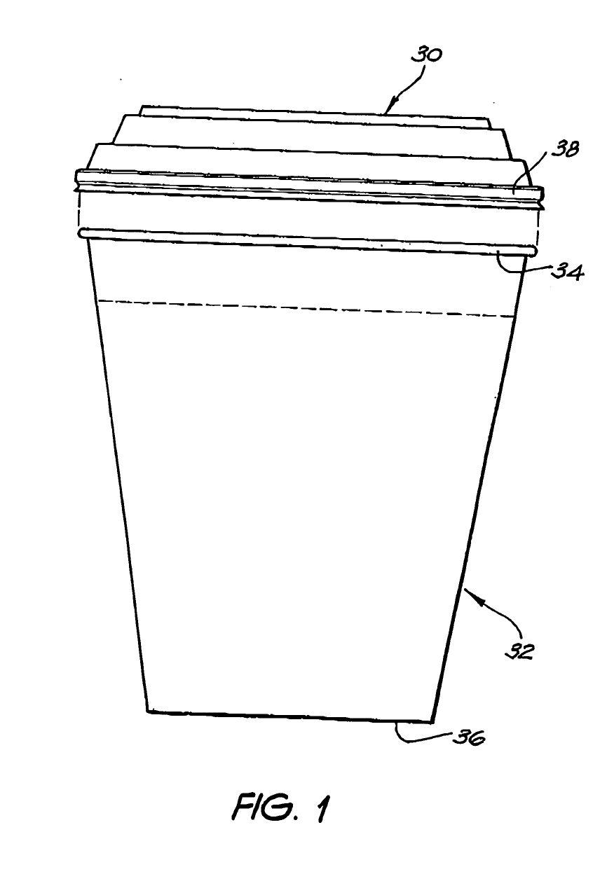

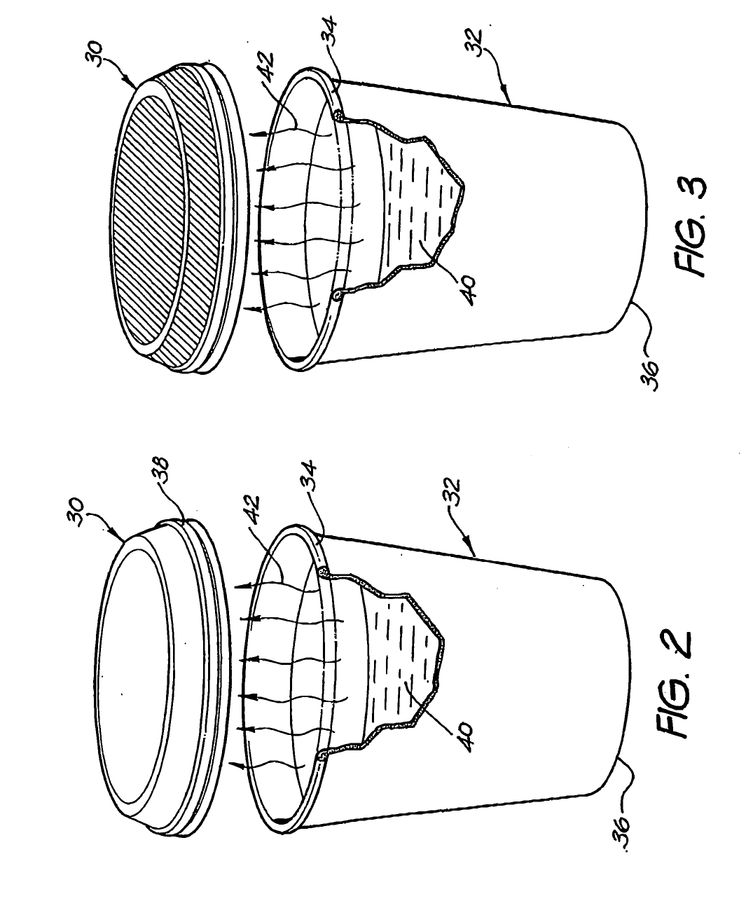

Referring firstly to FIGS. 1 to 3, there is shown a lid 30 according to a first embodiment of the invention. The lid 30 is for use with a disposable beverage container, in the form of polystyrene cup 32, as are commonly used in the sale of coffee. The cup 32 includes an open end surrounded by a circular rim 34 and a closed end defined by a circular flat base 36. The lid 30 includes a peripheral skirt 38 adapted to substantially sealingly engage with the rim 34 of the cup 32, as is well known in the art.

The construction and external shape of the lid 30 is substantially identical to known commercially available high impact polystyrene (HIPS) lids, except the lid 30 also includes therein a material having thermochromic properties, preferably thermochromic pigment, as will be explained in more detail below. Materials having thermochromic properties, including but not limited to thermochromic pigments, are also known. Briefly, materials bat thermochromic properties change colour (hereinafter referred to as a thermochromic activation colour) upon reaching a determined temperature (hereinafter referred to as a thermochromic activation temperature). The colour is usually gradual from near the activation temperate and complete by the activation temperature. For example a thermochromic pigment with an activation temperature of 45 Degrees Celcius would begin changing to the thermochromic activation colour at about 45 Degrees Celcius, with the colour charge being complete by 45 Degrees Celcius.

In use, the cup 32 is filled with contents 40 which, in the present embodiment, would be hot coffee. After the cup 32 has been filled with the hot contents 40, the lid 30 is applied in the known manner to seal the open end of the cup 32 about the rim 34. Heat transfer then occurs between the heated contents 40 and the (ambient temperature) lid 30, as generally indicated by arrows 42. When the heat transfer is sufficient to heat the lid 30 from ambient temperate to a predetermined thermochromic action temperature of the thermochromic pigment within the lid 30, the thermochromic properties of the pigment cause the lid 30 to change colour, as indicated by the shaded portions of the lid shown in FIG. 3. As an example, when the lid 30 is used with cups of hot coffee, a thermochromic pigment is chosen with a thermochromic activation temperature of 45 Degrees Celsius and an thermochromic activation colour of bright red. The

When used with heated beverages, as described in relation to FIGS. 1 to 3, the lid 30 preferably presents a violet or similar colour when at ambient temperate and a bright red colour when heated to the thermochromic activation temperature, which provides an intuitive indication that the contents of the cup 32 are hot.

When the content 40, and thus the lid 30, have cooled to below the thermochromic activation temperature, the lid 30 returns to its original colour to indicate that the contents 40 have cooled.

When the cup 32 is to be used with chilled beverages, a thermochromic pigment is selected with a thermochromic activation temperature of, for example, 5 Degrees Celsius and an activation colour of blue. When the lid 30 has been chilled to 5 Degrees Celsius due to heat transfer from the (ambient temperature) lid 30 to the chilled contents 40, the lid 30 turns a blue colour to indicate that the contents are at the predetermined chilled temperature. Again, when the contents 40, and thus the lid 30, warm to above the thermochromic activation temperature, the lid 30 returns to its original violet colour to indicate the contents 40 are no longer chilled.

FIG. 4 shows a lid 44 according to the second embodiment of the invention and like reference numerals to those used in describing the first embodiment will be used to denote like features. The lid 44 is similar to the lid 32 according to the first embodiment except it includes am opening 45a to allow a user to consume the contents 40 without removing the lid 44 from the cup 32 and an area 45b without thermochromic properties to allow advertising, consumer or other information or indicia to be applied to the lid 44.

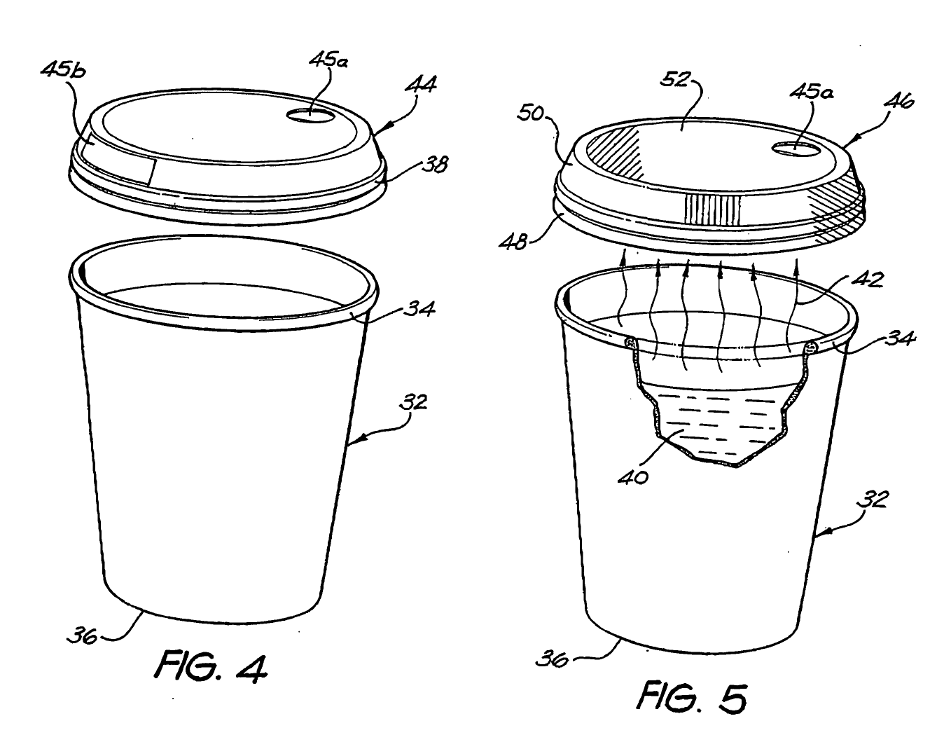

FIG. 5 shows a lid 46 according to a third embodiment of the invention and like reference numerals to those used in describing the first and second embodiments will be used to denote like features. The lid 46 is also similar to the lid 30 according to the first embodiment of the invention except different regions of the lid have been produced using thermochromic pigments of differ activating temperatures so that different parts of the lid, for example rim 48, lid side wall 50 and top 52 can each be configured to change colour at differing temperatures (eg. 40, 45 and 50 Degrees Celsius respectively), to provide a progressive indication of temperature.

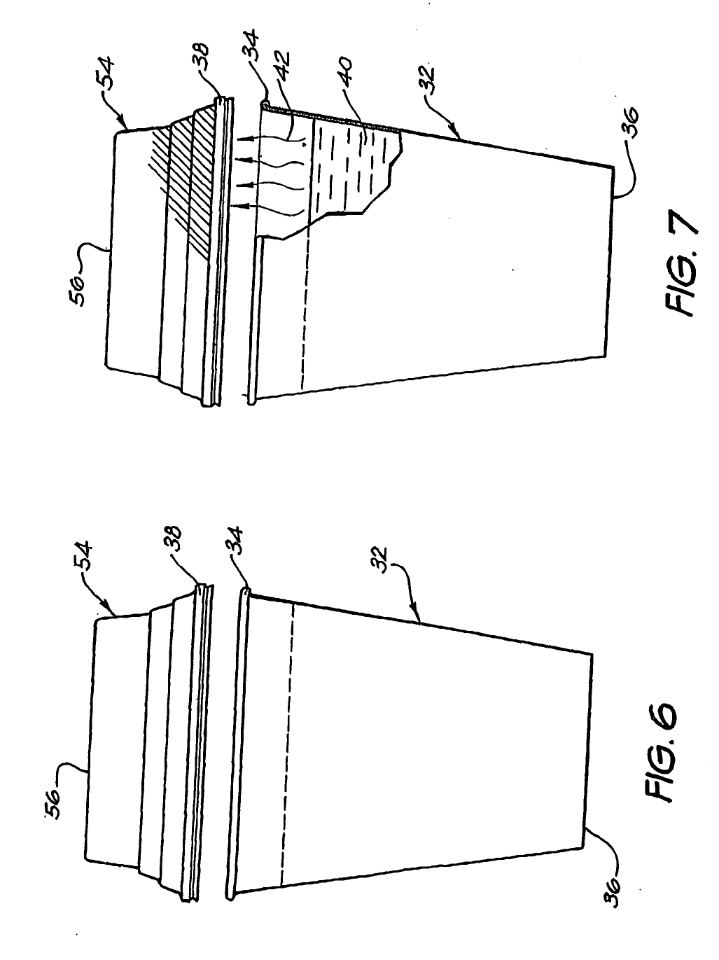

FIGS. 6 to 9 show a lid 54 according to a fourth embodiment of the invention and like reference numerals to those used in describing the previous embodiments will be used to denote like features. The lid 54 is similar to the lid 30 according to the first embodiment of the invention except it has a slightly more raised top surface 56. Importantly, the lid 54 includes the skirt 38 which is adapted to substantially sealingly engage with the rim 34 of the cup 32.

As with earlier embodiments, the shaded portion of the lid 54 shown in FIG. 7 demonstrates that the thermochromic pigment in the lid 54 causes it to change colour when heat transfer from the contents 40 of the cup 32 cause the lid 54 to reach a predetermined thermochromic activation temperature.

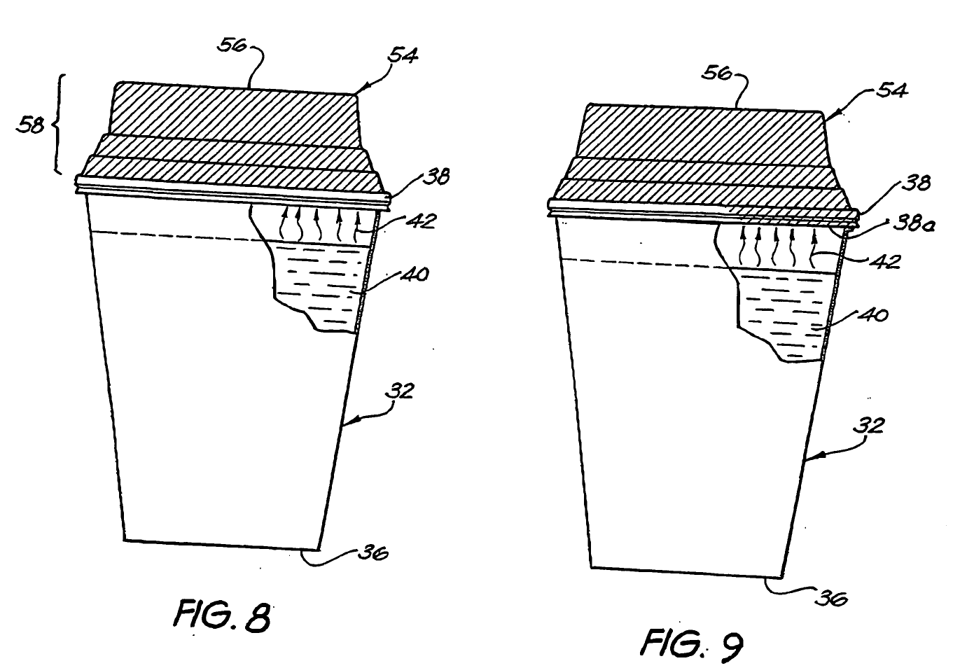

FIG. 8 shows the lid 54 and the cup 32 when the lid 54 has been correctly applied to the cup 32 and the skirt 38 covers, and is engaged with, the rim 34 of the cup 32 about its entire periphery. In this position, the rim 34 effectively insulates the skirt 38 from heat transfer with the contents 40 of the cup 32. Accordingly, as shown, only parts 58 of the lid 54 other than the skirt 38 change colour upon reaching the predetermined thermochromic activation temperature. However, as shown in FIG. 9, if the skirt 38 is not completely sealed with respect to the rim 34 then hot vapours or similar can pass through the gap between the unsealed portion of the skirt 38 and the rim 34, causing heat transfer and an associated colour change in the unsealed portion 38a of the skirt 38. Accordingly, applying thermochromic material to all of the lid 54 including the skirt 38, or only the skirt 38, can be used to provide a visual indication as to whether or not the lid 54 is properly sealed with respect to the cup 32, as can occur due to operator error, for avoidance of spillage and the like.

The lid embodiments described above are preferably all moulded, particularly vacuum moulded, with thermochromic pigments introduced to the molten plastics material (HIPS) before moulding. The preferred method of producing the thermochromic regions of the lids involve co-extruding two layers of HIPS. The inner layer (ie. that adjacent the contents of the cup in use) of HIPS is produced conventionally and with a base pigment of either white or a grey tone to add a depth of colour to the lid. The outer layer (ie. that remote the content of the cup in use) is produced from a clear HIPS to which has been added approximately 7 to 20, preferably 10, percent by weight of a thermochromic pigment and 2 to 3 percent of a standard pigment of a similar colour to the activated colour of the thermochromic pigment. The thermochromic pigments themselves are commercially available from several sources including, for example, those denoted F4, G7 or J8 and sold under the trademark CHROMICOLOR by Matsui International Co. Inc. of Gardena, Calif., United States of America.

The advantages of the lids according to the embodiments described above are many. For example, the lids can be used in the case of hot beverages to include a warning to the individual with the container, and those they may be approaching, that there are hot and potentially hazardous contents contained therein. In the case of billed contents, the previously described embodiments of lids provide an indication that the contents have been chilled to a temperature expected by the consumer.

The lids also provide an improved indication of temperature to individuals with reduced eyesight, numbness of the fingers or those who handle containers in darkened environments.

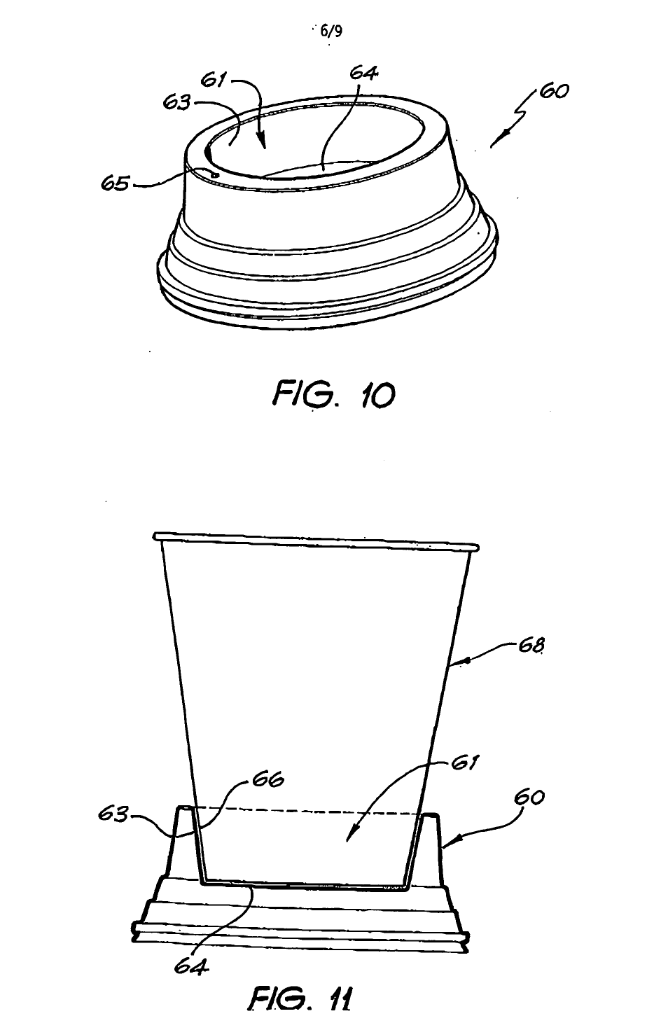

FIGS. 10 and 11 show a lid 60 according to a fifth embodiment of the invention. The lid 60 includes a recess 61 having a substantially cylindrical slightwardly outwardly conical internal side wall 63 around a flat surface 64. The lid 60 also includes a vent hole 65, as is well known in the art.

As best shown in FIG. 11, the internal side wall 63 substantially corresponds in size and shape to the external side wall 66 that define the closed end of an associated container, such as cup 68. Accordingly, when the closed end of the contain 68 is positioned within the recess 61 of the lid 60, the lid internal side wall 63 securely frictionally engages, over substantially its entire surface area, the external side wall 66 of the container 68. More particularly, in relation to a standard volume 8 Ounce (237 mls) coffee cup, the side walls 64 and 66 engage over approximately 10 mm (10 percent) of the height of the container.

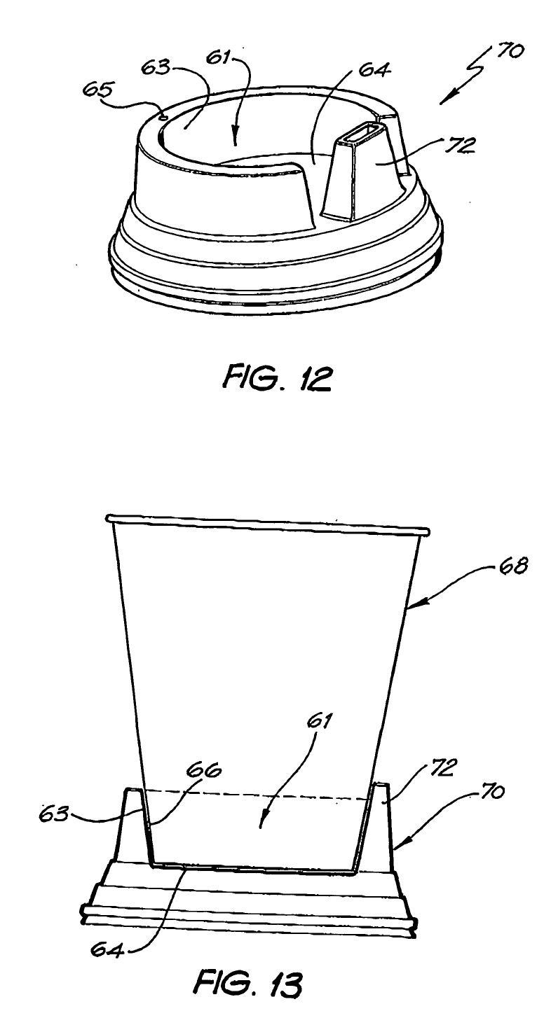

FIGS. 12 and 13 show a lid 70 according to a sixth embodiment of the invention and like reference numerals to those used in describing the fifth embodiment will be used to denote like features. The lid 70 is similar to the lid 60 according to the fifth embodiment except the internal side wall 63 does not extend around the ere lid periphery and instead has a portion removed to allow room for provision of a drinking spout 72.

FIG. 14 shows a lid 74 according to a seventh embodiment of the invention and like reference numerals to those used in describing the fifth and sixth embodiments will be used to denote like features. The lid 74 is substantially identical to the lid 60 according to the fifth embodiment except the recess 61 is deeper and provides a side wall 76 that engages with the external side walls of a corresponding container (not shown) over approximately 20 mm (10 percent) of the height of the container.

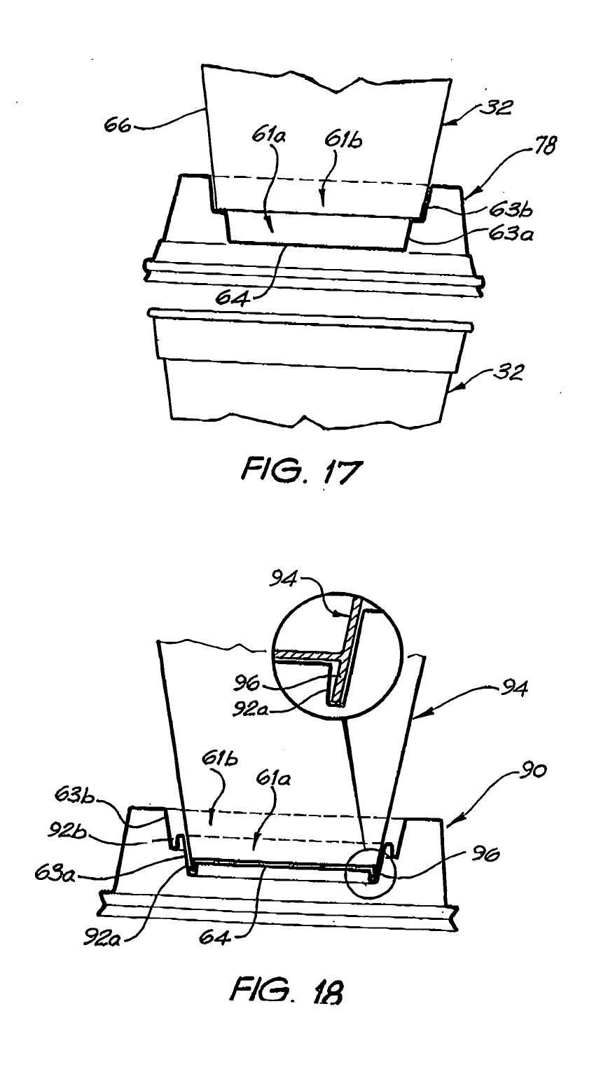

FIGS. 15 and 17 show a lid 78 according to an eighth embodiment of the invention and like reference numerals to those used in describing the fifth to seventh embodiments will be used to denote like features. The lid 78 is substantially identical to the lid 74 of the seventh embodiment except it includes two recess 61a and 61b surrounded by respective side walls 63a and 63b. The recess 61a is, in use, adjacent the associated cup's open end and adapted to engage a smaller container compared to the recess 61b, which is remote the cup's open end and adapted to engage a relatively larger container. This allows the lid 78 to seal one of either a larger or smaller size cup and have another of the larger or smaller size cup engaged therewith by stacking (larger 32 cup shown).

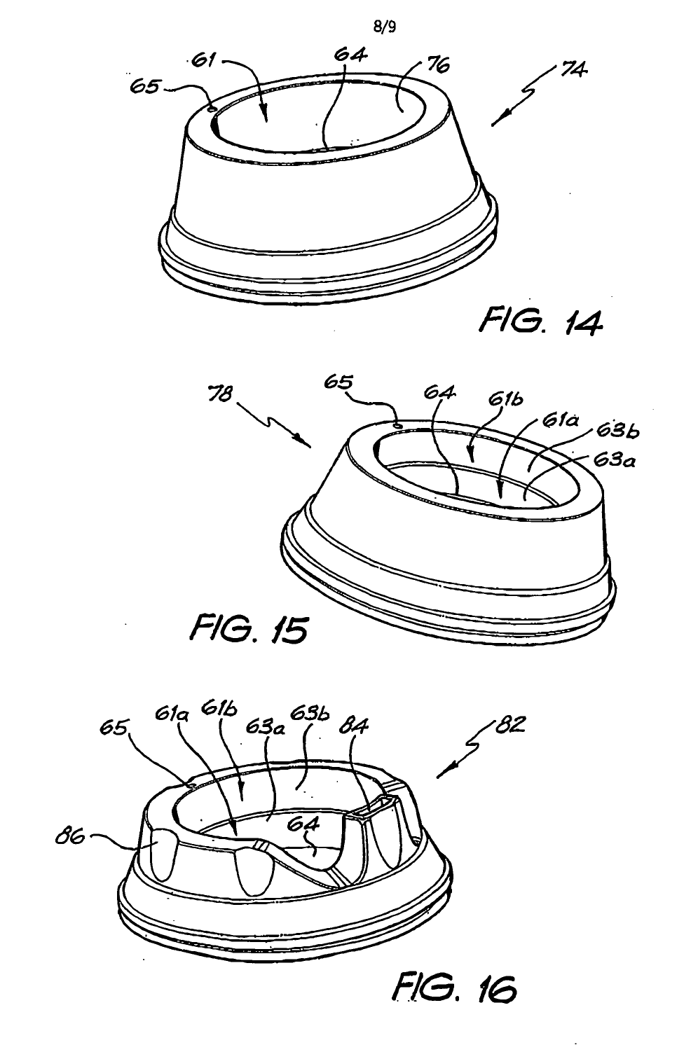

FIG. 16 shows a lid 82 according to a ninth embodiment of the invention and like reference numerals to those used in describing the fifth to eighth embodiments will be used to denote like features. The lid 82 is substantially identical to the lid 78 of the eighth embodiment except it includes a drinking spout 84 and external depressions 84, which serve to increase the structural rigidity of the lid 82.

FIG. 18 shows a lid 90 according to an tenth embodiment of the invention and like reference numerals to those used in describing the fifth to ninth embodiments will be used to denote like features. The lid 90 is for use with a paper cup 94 is substantially identical to the lid 86 of the ninth embodiment except the lower edges of the recesses 61a and 61b continue as grooves 92a and 92b respectively, which serve to receive and engage a peripheral edge 96 on the underside of the paper cup 94. The lid 90 is shown engaged with a smaller cup.

The main advantage of the lids according to the fifth to twelth embodiments of the invention is they provide a secure gripping engagement with the underside of a correspondingly sized container, such that when the lids are secured to a primary container they can be engaged with a secondary stacked container in a secure fashion to provide for ease of carrying multiple stacked containers.

Although the invention has been described with reference to specific examples, it will be appreciated to those skilled in the art that the invention may be embodied in many other forms. Particularly, the thermochromic features of the first five embodiments can be incorporated with the stacking features of the site to twelth embodiments and vice versa.

1. A lid for a disposable beverage container, the lid including at least a region having thermochromic properties which is/are adapted to change colour upon reaching a predetermined non-ambient temperature in response to heat transfer from or to contents of the container.

2. A lid as claimed in claim 1, wherein the region is substantially all of the lid.

3. A lid as claimed in claim 1, wherein the lid includes a skirt adapted to substantially sealingly engage an open end of the container and the region is the skirt.

4. A lid as claimed in claim 1, 2 or 3, wherein the region changes from a first colour to second colour, of brighter or warmer tones than the first colour, when the contents are at the predetermined non-ambient temperature.

5. A lid as claimed in claim 1, 2 or 3, wherein the region changes to a bright red colour colour when the contents are at a predetermined heated non-ambient temperature.

6. A lid as claimed in claim 5, wherein the region is violet when the contents are below the predetermined heated non-ambient temperature.

7. A lid as claimed in claim 6, wherein the predetermined heated non-ambient temperature is about 45 Degrees Celsius.

8. A lid as claimed in claim 1, 2 or 3, wherein the region changes to a blue colour when the contents are at a predetermined chilled non-ambient temperature.

9. A lid as claimed in claim 9, wherein the region is violet when the contents are above the predetermined chilled non-ambient temperature.

10. A lid as claimed in claim 6, wherein the predetermined chilled non-ambient temperature is about 5 Degrees Celsius.

11. A lid as claimed in any one of the preceding claims, wherein the lid is formed from a plastics material in which the region(s) are impregnated or blended with a material having thermotropic properties.

12. A lid as claimed in claim 11, wherein the material having thermochromic properties is a thermochromic pigment, resin or the like.

13. A lid as claimed in claim 12, wherein the material having thermochromic properties is CHROMICOLOR (Trade Mark).

14. A lid as claimed in any one of the preceding claims, wherein the region(s) form words, symbols or patterns against the remainder of the lid when the contents are at the predetermined non-ambient temperature.

15. A lid as claimed in any one of the preceding claims, wherein the region(s) are adapted to return to their original colour in response to the temperature of the regions falling below the predetermined non-ambient temperature when that temperature is above ambient or rising above the predetermined non-ambient temperature when that temperature is below ambient.

16. A lid as claimed in any one of the preceding claims, the lid including at least two regions having differing thermochromic properties which are each adapted to change to different colours upon reaching differing non-ambient temperatures in response to heat transfer from or to the contents of the container.

17. A lid as claimed in any one of the preceding claims, wherein the lid is formed from a co-extruded outer and inner layer and the region(s) having thermochromic properties is/are only in the outer layer.

18. A lid for a disposable beverage container, the container having an open end and a closed end defined by external side wall or walls, the lid including at least one recess having an internal side wall or walls that substantially correspond to the container external side wall(s) in size and shape, wherein the lid internal side walls are adapted to securely frictionally engage, over substantially their entire surface area, the external side wall(s) of another like container.

19. A lid as claimed in claim 18, wherein the lid internal side wall(s) engage the external side wall(s) of said another like container over approximately 5 to 15% of the height of said another like container.

20. A lid as claimed in claim 19, wherein the lid internal side wall(s) engage the external side wall(s) of said another like container over approximately 10% of the height of said another like container.

21. Lid as claimed in claim 18, wherein the lid internal side wall(s) engage the external side wall(s) of said another like container over approximately 5 to 15 mm of the height of said another like container.

22. A lid as claimed in claim 21, wherein the lid internal side wall(s) engage the external side wall(s) of said another like container over approximately 10 mm of the height of said another like container.

23. A lid as claimed in claim 18, wherein the lid includes two recesses each having said internal side wall(s), one of the recesses adapted to frictionally engage the closed end of another like container and the other of the recesses adapted to frictionally engage the closed end of another container of smaller or larger size than a like container.

24. A lid as claimed in claim 19, wherein the recess adjacent the container open end is smaller than the recess remote the container open end.

25. A lid as claimed in claim 23, wherein the lid internal side wall(s) of each recess engage the external side wall(s) of said another like contain over approximately 2.5 to 7.5% of the height of said another like container.

26. A lid as claimed in claim 25, wherein the lid internal side wall(s) of each recess engage the external side wall(s) of said another like container over approximately 5% of the height of said another like container.

27. Lid as claimed in claim 23, wherein the lid internal side wall(s) engage the external side wall(s) of said another like container over approximately 2.5 to 7.5 mm of the height of said another like container.

28. A lid as claimed in claim 27, wherein the lid internal side wall(s) of each recess engage the external side wall(s) of said another like container over approximately 5 mm of the height of said another like container.

29. A lid as claimed in any one of claims 18 to 28, wherein the recess(es) is/are substantially cylindrical.

30. A lid as claimed in any one of claims 18 to 29, wherein the recess(es) is/are slightly outwardly conical.

31. A lid as claimed in any one of claims 18 to 30, wherein the recess(es) each include a flat surface adjacent one end of the side wall(s) adapted to, in use, abut the underside of said another like container closed end.
